(19) United States
(12) Patent Application Publication
(10) Pub. No.: US 2007/0229510 A1
(43) Pub. Date: Oct. 4, 2007

(54) Displaying of Vector Graphics, in Particular of Geographical Maps

(76) Inventor: Alain Rey, Paris (FR)

Correspondence Address: STITES & HARBISON PLLC, 1199 NORTH FAIRFAX STREET, SUITE 900, ALEXANDRIA, VA, 22314, US

(21) Appl. No.: 11/574,584

(22) PCT Filed: Aug. 26, 2005
(86) PCT No.: PCT/FR05/02155

§ 371 Date: Mar. 2, 2007

(30) Foreign Application Priority Data
Sep. 2, 2004 (FR) 0409296

(51) Int. Cl. G06T 11/20

(52) U.S. Cl. 345/443

(57) ABSTRACT

The simplification/reconstruction processing of an image comprising areas delimited by polygonal lines whose points defining said lines are initially stored in a memory consists in organising sets of remaining points of each line after different initial image simplifications with different simplification ratios in a hierarchical database (SER) and, for processing a reconstruction (33), in using the identifier of the selected simplification ratio for recovering the database of points enabling to reconstruct the image having the selected simplification ratio.

The present invention relates to a processing of digital image data in the form of a vector graphic, in particular by simplification/reconstruction of an image comprising regions bounded by polygonal lines, such as a geographical map.

Simplification/reconstruction processing, an example of which is described in detail below, is used notably in the application of a zoom-in/-out, respectively, to an image in the form of a vector graphic.

A preferred, but in no way limiting, application aims the downloading of such image data, such as a geographical map, onto a terminal, notably a mobile terminal, from a local or remote server and via a telecommunications network.

Notably in this context, it is desirable for a user of the terminal to be able, on the one hand, to download the image data onto his terminal and, on the other, to navigate within the image, as quickly as possible. ‘Navigate within the image’ is typically understood as the process of zooming in and out on a geographical map, or alternatively making “lateral” displacements within the map, referred to as ‘drag-and-drop’ operations, in other words displacements in the plane of the map at a constant scale factor.

However, when the terminal displays a first image and the user wishes to display a second image, for example corresponding to a zoom of the first image, the terminal reconnects to the server in order to systematically download all the image data of the second image. Firstly, this process adds on download waiting times and, ultimately, the telecommunications costs. Secondly, it considerably limits the interactive nature of the exchanges with the server.

The present invention aims to improve this situation.

For this purpose, one subject of the invention is a method for processing digital image data in the form of a vector graphic, in which, in order to process by simplification/reconstruction an image comprising regions bounded by polygonal lines:
a) for all the polygonal lines, the points defining said polygonal lines are stored in a memory,
b) a database is organized by storing in the form of a hierarchy, as a function of a simplification coefficient identifier, the points remaining from each polygonal line after simplifications of the initial image with respective simplification coefficients, and
c) for reconstruction processing, a chosen simplification coefficient identifier is utilized in order to recover from said database points allowing the image to be reconstructed to said chosen simplification coefficient.

These steps are preferably conducted at a server capable of cooperating with a terminal within a network of the aforementioned type. In this context, the image data is downloaded from a server toward a terminal, and:
the aforementioned database is composed at the server,
the aforementioned points resulting from a simplification are downloaded from the server according to a request from the terminal comprising a simplification coefficient identifier, and
the terminal constructs and displays a simplified image according to the simplification coefficient identified.

Another subject of the present invention is the application of the method according to the invention to the displaying of geographical maps in the form of vector graphics.

A further subject of the present invention is a system for the implementation of the method, this system comprising a terminal and a server linked via a telecommunications network, for the displaying of vector graphics on the terminal.

Another subject of the present invention is a server of such a system, together with a terminal of such a system.

A further subject of the present invention is a computer program product designed to be stored in a memory of a server of such a system, and comprising instructions for:
reading data for points of a vector image,
determining common borders between regions of said image, in the form of polygonal lines, and
launching all or some of the steps of the method according to the invention.

Another subject of the invention is the data structure of the aforementioned database for the implementation of the method according to the invention.

A further subject of the present invention is a computer program product designed to be stored in a memory of a terminal of a telecommunications network, and comprising instructions for:
reading data having the aforementioned data structure, and
displaying, starting from this data, an image on a display screen that the terminal comprises.

Other advantages and features of the invention will become apparent upon reading the detailed description hereinafter and from the appended drawings in which:

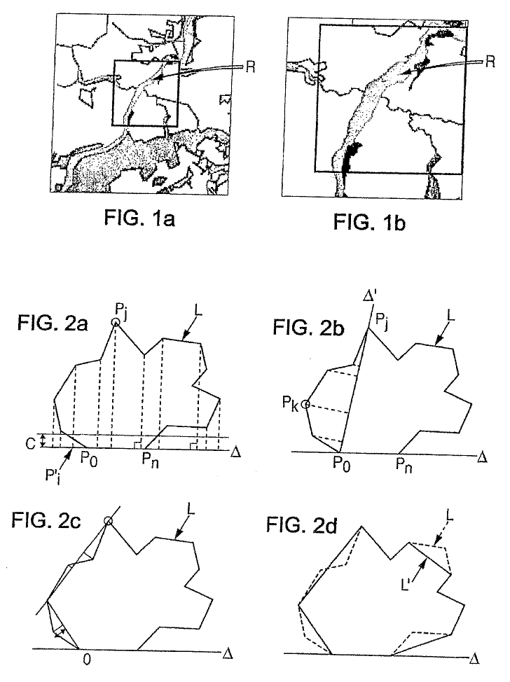

FIGS. 1a and 1b respectively show a geographical map and a zoom-in applied to this map,

FIGS. 2a to 2d show schematically a polygonal line to be simplified, at various steps of simplification processing according to the algorithm known as ‘Douglas-Peucker Algorithm’,

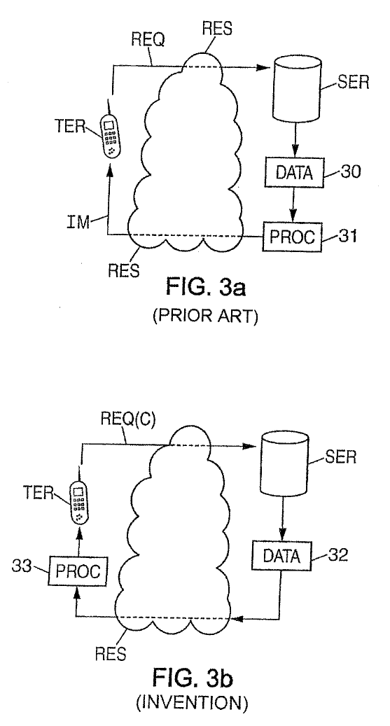

FIGS. 3a and 3b show schematically the exchanges between a terminal and a server, according to the prior art and according to the invention, respectively,

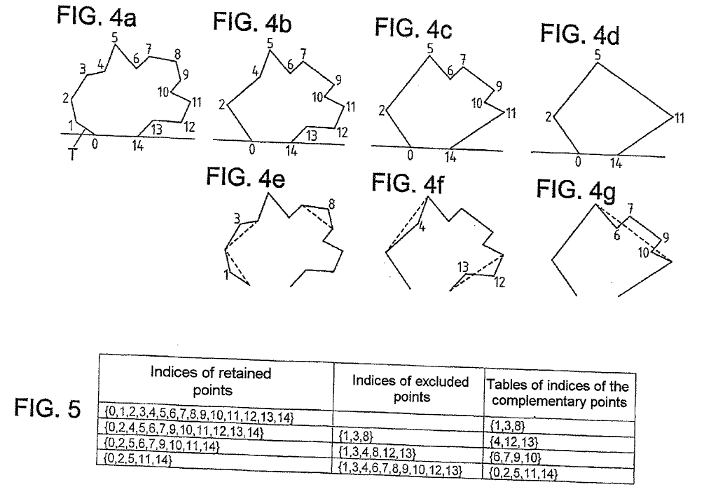

FIGS. 4a to 4d show schematically a polygonal line at different, increasing degrees of simplification and

FIGS. 4e to 4g illustrate the complementary points of the respective successive simplifications,

FIG. 5 shows a table of the indices of the retained points (first column), excluded points (second column), and complementary points (third column), after each simplification in FIGS. 4a to 4d,

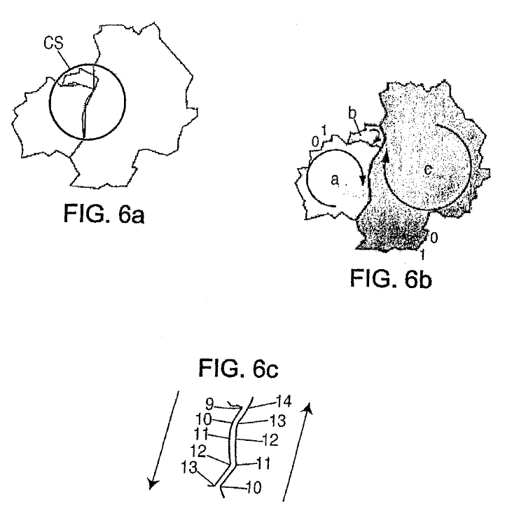

FIGS. 6a, 6b and 6c respectively show an aberration in simplification/reconstruction, a direction given to the polygonal lines according to a preferred embodiment of the invention, and a blow-up of the border common to the objects a and c in FIG. 6b,

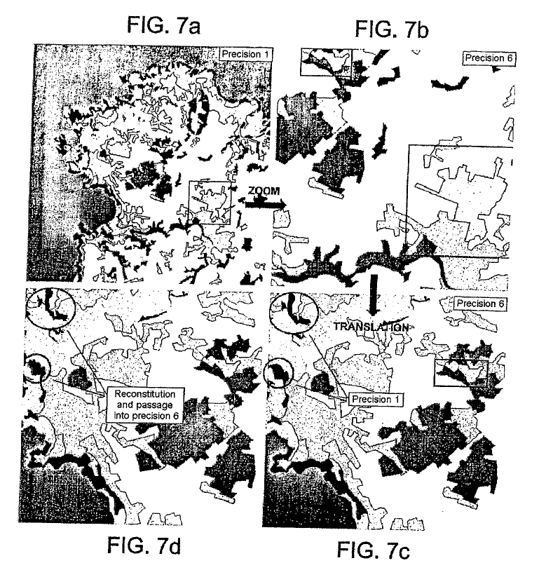

FIGS. 7a to 7d respectively show an initial image, a zoom-in onto this initial image, a translation along a ‘drag-and-drop’ displacement and a local reconstruction adhering to the precision at the requested scale.

First of all, it is pointed out that the invention may be advantageously applied to digital cartography, referred to as ‘geomatics’. Following on from the conventional organizations called ‘Geographical Information Systems’, existing for many years and equipping design offices, local and regional bodies, water departments, technical services, or others, numerous applications designed for the general public today allow maps to be consulted, notably by downloading via the Internet. These applications are divided into two main families:
the applications known as ‘raster’, offering maps in the ‘image’ or ‘bitmap’ format and corresponding to an assembly of pixels, and
the applications known as ‘vector’, which deliver maps composed of mathematical objects such as straight lines, segments, polygonal lines, allowing geographical objects to be represented more or less faithfully.

Whatever the nature of a geomatics program, of the raster or vector type, the compression of the data is crucial whenever it is transmitted over a telecommunications network in the framework of a client/server architecture.

Raster applications mainly use compression by wavelets, the compressed GIF format or else JPEG format. In contrast, there is no existing compression processing for vector applications, in the prior art known to the Applicant.

Reference is made to FIGS. 1a and 1b in order to describe an example of simplification/reconstruction processing. The processing known as ‘generalization’, in cartography, consists in simplifying a trace as a function of the scale at which it is represented in order to make it easier to read for the user, while at the same time endeavoring to best preserve its geometry. Thus, at 1/50000^{th}, and 1/25000^{th}, a tributary R will be respectively represented by a rough approximation of its bed (FIG. 1a), then by a trace comprising all the curvatures followed by its path from the source to the river (FIG. 1b).

This principle of loss of precision as a function of the scale is also called polygonal reduction in fields such as digital geometry or computer-generated images. In this case, it is then a question of ‘relieving’ the processing of a certain amount of point information judged to be non-relevant or insufficiently significant on the geometry of the object being processed.

For this purpose, a few different polygonal reduction algorithms have been written. Amongst these processing operations, the Hakimi-Schmeichel, the Imai-Iri, and in particular the Douglas-Peucker algorithm, which will be described hereinbelow, may notably be mentioned.

The majority of these algorithms require the input of an arbitrary numerical value, called reduction coefficient, which determines the loss of precision that will be applied to the original trace. Typically, the greater this coefficient, the lower the precision of the trace obtained.

These algorithms may be divided into two families:
those whose resulting trace runs through points belonging to the original trace, and
those that generate new points with respect to the initial object.

The Douglas-Peucker algorithm belongs to the first family.

Reference is now made to FIGS. 2a to 2d in order to describe this algorithm.

A polygonal line L formed from n+1 points numbered 0 to n and denoted {P0, P1, . . . , Pn} is considered. Firstly, the straight line Δ(P0Pn) is traced passing through P0 and Pn and the distance to this straight line from all the remaining points, namely P1 up to Pn−1, is calculated. For this purpose, the orthogonal projections P′i of each of these points onto the straight line Δ are calculated. The distances between the points Pi and P′i, for all i included in the range between 1 and n−1, are subsequently calculated. Then, each of these distances is compared with a coefficient C, called ‘reduction coefficient’, given as initial parameter when the algorithm is launched. If this distance between Pi and P′i is less than the coefficient C, the point Pi will be able to be eliminated from the final trace (FIG. 2c).

Beforehand, the point Pj furthest from the straight line Δ is selected. This is the point whose distance Dj is the greatest (FIG. 2b). This point Pj will be conserved in the final trace (FIG. 2d). The sub-trace PjPn is subsequently put aside. Instead, the straight line Δ′(P0Pj) is traced (FIG. 2b), and for each of the points {P1, P2, . . . , Pj−1}, the steps described hereinabove are repeated, which may therefore be summarized as follows:
calculation of the orthogonal projections P′i onto the straight line Δ′,
comparison of the distances Pi to P′i with the coefficient C,
determination of the point Pk furthest from the straight line Δ′, and
putting aside, where appropriate, a sub-trace PkPj, to be processed later on, etc.

Typically, once the sub-trace P0Pj has been analyzed and processed, the sub-trace PjPn is then analyzed and processed in turn, following the same steps.

Finally, at the end of the processing operation, a simplified polygonal line, denoted L′, is obtained (FIG. 2d).

It will be noted that this Douglas-Peucker algorithm:
terminates itself automatically (by the principle of recursivity),
produces a trace containing n points at most, and
produces a trace containing a minimum of two points, P0 and Pn.

Furthermore, the greater the simplification coefficient C, the lower the number of points retained and the greater the loss of precision.

One of the features of this algorithm consists in the fact that, if T, T′ and T″ are respectively:
an original trace,
the original trace simplified by a coefficient C1, and
the original trace simplified by a coefficient C2 greater than C1,
   then all the points of the trace T′ are also points of the trace T′ which are themselves points of T.

Another feature shared by all the aforementioned reduction algorithms consists in the fact that the two ends of a reduced trace are the two ends of its original trace.

The inverse principle of the recovery of precision is now described.

This technique only makes sense with regard to a dynamic ‘vector’ map. By the term ‘dynamic’ is understood the possibility of performing a zoom-in into the map, in real time. Many known applications operate on the principle of client/server request at each displacement or zoom request from the client. The coordinates of the map, together with the nature of the motion (zoom or displacement), at the user end, are sent to the server. In this context of the prior art, the server recalculates the updated map, then transmits the image obtained to the client, as shown in FIG. 3a.

With reference to this FIG. 3a, relating to the prior art, upon a request REQ from the terminal TER, the server SER:
extracts, at step 30, all the data from the initial image, unsimplified,
calculates, at step 31, for example a simplification of the image because a zoom-out would have been requested by the user of the terminal TER, and
transmits the data IM thus processed via the telecommunications network RES.

It goes without saying that the request REQ from the terminal, like the transmitted image data IM, passes through the telecommunications network RES.

With reference to FIG. 3b, relating to the invention, the method according to the invention is differentiated from this type of prior art notably in that the terminal TER has at its disposal all the information necessary for the zoom and the displacement, as will be seen later, and, more particularly, is capable, using series of points which are a function of successive simplification coefficients ordered in the direction of the increasing scales (decreasing values of simplification coefficients), of displaying the map on a display screen that it comprises (not shown).

For example, if the user has requested a zoom-in, additional points, allowing the map to be displayed at a larger scale, are downloaded from the server SER (step 32) as follows:
passing through one of the aforementioned stages generates a specific call REQ(C) toward the server SER,
the server SER then returns the complementary points allowing the recovery of the precision relating to the scale of the map (step 32),
upon receiving these additional points, the terminal TER integrates these new points on-the-fly into an existing list, relating to the preceding trace (un-zoomed), and updates this list (step 33).

The specific call from the terminal toward the server has been represented by the abbreviation REQ(C) in FIG. 3b because this request notably depends on the simplification coefficient C associated, in the database of the server SER, with the points that are requested by the terminal TER in order to perform, for example, a zoom-in of an image being displayed.

It is pointed out that a choice of zoom for the user (notably of zoom-in) can consist of several successive changes in scale, from a first scale up to a second scale at which the trace contains all of the points of the original image. This technique considerably reduces, at the server end, the volume of the data to be transmitted, and also the execution time of the processing operations. Finally, these processing operations are limited to a few transmissions of simple requests, since a program, at the terminal end, is able to interpret and process the data received.

In general terms, it will be understood that the server SER therefore comprises a database comprising at least:
a first set of points associated with a first simplification coefficient, and
a second set of points, associated with a second simplification coefficient of lower value than the first coefficient, complementary to the points of the first set for the reconstruction of the image according to the second simplification coefficient.

The principle of the method that is the subject of the invention is detailed hereinafter, with reference to FIGS. 4a to 4g.

In FIG. 4a, a trace T contains n+1 points denoted {P0, P1, . . . , Pn}. This trace is reduced according to a coefficient C1, in order to obtain a trace T1 containing i+1 points denoted {P′0, P′1, . . . , P′i}.

Thus:
P0=P′0 and P′i=Pn
all the points of T1 are also points of T, or, in other words, no point of T1 exists that is not also a point of T,
i is less than or equal to n.

For any point P′j of the trace T1, k exists between 0 and n such that P′j=Pk. From this property a table of indices of points of the trace T1 is deduced, denoted I1. The set of the points identified by this table of indices is strictly included within the set of the points defining the initial trace T, denoted I. A table IC1 therefore exists that is complementary to I1 with respect to I such that IC1+I1=I.

A trace T that contains n+1 points denoted P0 to Pn, and its table of indices denoted I={0, 1, 2, . . . n}, can therefore initially be constructed, then a series of polygonal reductions be applied to this trace according to the successive reduction coefficients Cj such that C1<C2< . . . <Cj< . . . <Ck, in order to obtain a series of traces reduced from T, denoted T1 to Tk, and their respective tables of indices Ik.

There thus exists one and only one series of complementary index tables ICk such that:

$${\sum }_{j = 1}^{k} ICj + ICk = I$$

In the example in FIG. 4a, a trace T is shown containing 15 points, P0 to P14, and its table of indices I={0, 1, . . . 14} in FIG. 5. By applying three reductions, of coefficients C1<C2<C3, three traces T1, T2 and T3 are obtained. Referring to the table in FIG. 5, for the first reduction, the points of index {0, 2, 4, 5, 6, 7, 9, 10, 11, 12, 13, 14} are retained. After the second reduction, the points {0, 2, 5, 6, 7, 9, 10, 11, 14} are retained. After the third reduction, the points {0, 2, 5, 11, 14} remain.

In order to go from the trace T3 to the trace T2, it therefore suffices to re-insert the points excluded between the reduction C3 and the reduction C2, namely {6, 7, 9, 10}. In order to obtain T1, the points {4, 12, 13} just need to be added. Finally, in order to go from T1 to T, it suffices to add the points {1, 3, 8}.

A complementary processing operation included in a preferred embodiment of the invention, consisting in the search for ‘common borders’, is described hereinafter.

In cartography, many objects share common portions: counties, regions, rivers and roads, buildings and forests, or other. Now, applying a polygonal reduction of coefficient C to a set of geographical objects, independently from one another, leads to an aberration CS such as is shown by way of example in FIG. 6a, since the reduction algorithm leads, for the same coefficient, to two different reduced traces depending on the position of the end points of the traces.

The description that follows will provide a solution to this problem.

First of all, an initial analysis is performed in order to identify the geographical objects having a common portion of trace, called ‘common border’. Subsequently, if these objects are closed objects, their limits are displaced in index in order to place them on the end points of the common portions. The geographical objects are then divided up into segments. Lastly, each trace can be reconstituted by successively adding the points of its constituent segments.

However, even if a polygonal line does not really have a ‘direction’, in the mathematical sense of the term (different from a vector), a direction implicit in analytical geometry is assigned to the polygonal line, determined by the position of its first and second points, which defines directions for assigning indices to the points of the trace as shown in FIG. 6b.

Advantageously, the case where two traces have a common border, but opposite direction (as shown in FIG. 6c), is taken into account, otherwise their reconstitution would generate aberrant results.

This search for common borders is preferably iterative, as follows:
for a first stored geographical object, all the segments corresponding to the portions of its trace that are common to other geographical objects are sought, isolated, constructed and stored;
during these successive creation operations, an information data value from the sense of rotation of the indices in the first object, in the form of a code corresponding to an equality or to an inversion of the sense of rotation, is assigned to a second object having a segment in common with the first object.

Thus, when the common borders are sought for the second object, its list of segments already contains all those created, where applicable, by previous objects in the search for borders, together with the directions (or aforementioned senses of rotation) of these objects with respect to its own direction.

Once this second object has been processed, the following objects are subsequently processed, and so on.

In general terms, the method according to the invention comprises the following steps:
the successive points forming each polygonal line of the initial image are numbered,
the points of each of these lines are stored in the database of the server in correspondence with an order number in the polygonal line and with an identifier of the polygonal line to which it belongs,
if the initial image possesses several polygonal lines forming common borders between regions, including at least three borders having a common point, as shown in FIG. 6b, the numbering order of a border is preferably chosen as the inverse of the numbering orders of the two other borders.

A few applications of the method according to the invention are now described, notably for performing zoom and ‘drag-and-drop’ operations.

When the application is launched, each geographical object is reconstituted starting from its segments and from the points that these contain depending on the initial scale and on the initial reduction level. Subsequently, in the case of a zoom, once a certain stage has been crossed, triggering a call to the database for supply of complementary points, a filtering takes place at the terminal end. It is pointed out that, here, only the segments located in the displayed region on the display screen of the terminal are of interest, in order to limit the volume of data to be received and thus to enhance the smooth flow of the interactive application.

For example, a user performs a zoom in the center of a map, and thus passes through six stages out of ten stages that the application may have (passage from FIG. 7a to FIG. 7b). Then, the map is displaced (‘drag-and-drop’) toward the left (passage from FIG. 7b to FIG. 7c). A part of the geographical objects, in particular those contained in the displayed region when the zoom operates, is at precision 6, another part is at precision 5, another at precision 4, and so on (FIG. 7c). At the end of the displacement, a request REQ is then sent to the server in order to recover the complementary points of all the levels of precision that lack them, and an iterative reconstitution is performed where applicable (FIG. 7d).

Thus, in general terms, from amongst the aforementioned complementary points, some points to be used for the displaying of the image are selected within a window of pre-determined dimensions, corresponding for example to the dimensions of the display screen of the terminal.

Summing up the steps hereinabove, when the user of the terminal sends a zoom-in request to the server:
the terminal initially has at its disposal the points allowing an image to be displayed according to an initial simplification coefficient, within a window of given dimensions,
the terminal downloads from the server a selection of complementary points allowing the image to be displayed according to a simplification coefficient lower than the initial coefficient and corresponding to the level of zoom-in requested, the selection of these complementary points being carried out in order to display the image thus magnified in the aforementioned window.

This selection of the complementary points may, as indicated hereinabove, vary according to a choice, made by the user, of displacements of the image in the plane of the image and at a constant zoom level.

1. A method for processing digital image data in the form of a vector graphic, in which, in order to process by simplification/reconstruction an image comprising regions bounded by polygonal lines:
a) for all the polygonal lines, the points defining said polygonal lines are stored in a memory,
b) a database (SER) is organized by storing in the form of a hierarchy, as a function of a simplification coefficient identifier, the points remaining from each polygonal line after various simplifications of the initial image with various respective simplification coefficients, and
c) for reconstruction processing (33), a chosen simplification coefficient identifier is utilized in order to recover from said database points allowing the image to be reconstructed to said chosen simplification coefficient.

2. The method as claimed in claim 1, in which image data is downloaded from a server toward a terminal, characterized in that:
said database is composed at the server (SER),
said points resulting from a simplification are downloaded from the server according to a request (REQ(C)) from the terminal (TER) comprising a simplification coefficient identifier, and
the terminal constructs and displays a simplified image according to said simplification coefficient identified.

3. The method as claimed in either of claims 1 and 2, in which the successive points forming each polygonal line of the initial image are numbered, characterized in that the points of each of these lines are stored in the database in correspondence with an order number in the polygonal line and with an identifier of the polygonal line to which it belongs.

4. The method as claimed in claim 3, in which the initial image possesses several polygonal lines forming common borders between regions, including at least three borders having a common point, characterized in that the numbering order of a border is chosen as the inverse of the numbering orders of the two other borders.

5. The method as claimed in one of the preceding claims, characterized in that the database comprises at least:
a first set of points associated with a first simplification coefficient, and
a second set of points, associated with a second simplification coefficient of lower value than the first coefficient, complementary to the points of the first set for the reconstruction of the image according to said second simplification coefficient.

6. The method as claimed in claim 5, characterized in that, from amongst said complementary points, some points to be used for the displaying of the image are selected within a window of pre-determined dimensions.

7. The method as claimed in claim 6, taken in combination with claim 2, in which a user of the terminal sends a zoom-in request to the server, characterized in that:
the terminal (TER) initially has at its disposal the points allowing an image to be displayed according to an initial simplification coefficient, within a window of given dimensions,
the terminal downloads from the server a selection of complementary points allowing the image to be displayed according to a simplification coefficient lower than the initial coefficient and corresponding to the level of zoom-in requested, the selection of these complementary points being carried out in order to display the image thus magnified in said window.

8. The method as claimed in claim 7, characterized in that said selection of the complementary points varies according to a choice, made by the user, of displacements of the image in the plane of the image and at a constant zoom level.

9. The method as claimed in one of the preceding claims, characterized in that the simplification/reconstruction uses a processing operation according to an algorithm known as ‘DOUGLAS-PEUCKER Algorithm’.

10. An application of the method as claimed in one of the preceding claims to the displaying of geographical maps in the form of vector graphics.

11. A system for the implementation of the method as claimed in one of claims 1 to 9, characterized in that it comprises a terminal (TER) and a server (SER) linked via a telecommunications network (RES), for the displaying of vector graphics on the terminal.

12. A computer program product, for reconstruction/simplification processing of a digital image in the form of a vector graphic, designed to be stored in the memory of a telecommunications system including at least one server and one terminal, characterized in that it comprises, at the server end, instructions for:
a) storing in a memory points defining polygonal lines bounding regions that an image comprises, and
b) organizing a database (SER) by storing in the form of a hierarchy, as a function of a simplification coefficient identifier, the points remaining from each polygonal line after various simplifications of the initial image with various pre-determined respective simplification coefficients,
and, at the terminal end, instructions for:
c) utilizing said database, with a chosen simplification coefficient identifier, in order to recover from said database points allowing at least the image to be reconstructed to said chosen simplification coefficient.
